(19) United States
(12) Patent Application Publication
(10) Pub. No.: US 2026/0077322 A1
(43) Pub. Date: Mar. 19, 2026

(54) PAINT CAN MIXER DEVICES AND METHODS

(71) Applicants: Leonard Salati, Bronx, NY (US); Fernando Salati, Bronx, NY (US); Leonard Bujaj, Bronx, NY (US)

(72) Inventors: Leonard Salati, Bronx, NY (US); Fernando Salati, Bronx, NY (US); Leonard Bujaj, Bronx, NY (US)

(21) Appl. No.: 18/885,625

(22) Filed: Sep. 14, 2024

(51) Int. Cl. B01F 27/091; B01F 27/072; B01F 27/112; B01F 27/191; B01F 27/906; B01F 35/213; B01F 35/22; B01F 35/45; B01F 101/30; B44D 3/00; B44D 3/08; G01J 3/46; G01J 3/50

(52) U.S. Cl. CPC B01F 27/091; B01F 27/0722; B01F 27/112; B01F 27/191; B01F 27/906; B01F 35/213; B01F 35/2207; B01F 35/45; B44D 3/003; B44D 3/08; G01J 3/463; G01J 3/50; B01F 2101/30

(57) ABSTRACT

The embodiments disclose a paint can mixer system including a ratcheted turn knob coupled to a mixer axle configured to apply force to the mixer axle, a rachet device having a rachet bar coupled to the ratcheted turn knob configured to engage the ratchet device when the ratcheted turn knob is twisted in one direction, a plurality of mixing blades coupled to the mixer axle configured to mix paint in a paint can when the mixer axle is rotated, a suction cup coupled to the mixer axle configured to couple through suction to the paint can to stabilize the mixer axle during rotation, and a squeegee coupled to the mixer axle in contact with the bottom surface of the paint can be configured to mix solid paint pigments settled in the corners and surfaces of the bottom of the paint can.

### BACKGROUND

Painting can be a messy project due to the preparation and stirring of paint to get the correct homogenous mix of color and additives. Once the paint can lid is removed paint can be splashed out of the can and stain nearby objects and in many cases requires solvents to clean up.

### BRIEF DESCRIPTION OF THE DRAWINGS

FIG. 1 shows for illustrative purposes only an example of a paint can mixer of one embodiment.

FIG. 2 shows for illustrative purposes only an example of foldable mixing blades of one embodiment.

FIG. 3A shows for illustrative purposes only an example of a mixing handle of one embodiment.

FIG. 3B shows for illustrative purposes only an example of a ratcheted stirring device of one embodiment.

FIG. 4A shows for illustrative purposes only an example of blade hinges of one embodiment.

FIG. 4B shows for illustrative purposes only an example of mixing blades folded of one embodiment.

FIG. 5 shows for illustrative purposes only an example of the mixing blades deployed in the paint can of one embodiment.

FIG. 6 shows for illustrative purposes only an example of the bottom and corner squeegee of one embodiment.

FIG. 7 shows for illustrative purposes only an example of a paint color-matching app of one embodiment.

### DETAILED DESCRIPTION OF THE INVENTION

In the following descriptions, reference is made to the accompanying drawings, which form a part hereof, and which are shown by way of illustration a specific example in which the invention may be practiced. It is to be understood that other embodiments may be utilized and structural changes may be made without departing from the scope of the present invention.

It should be noted that the descriptions that follow, for example, in terms of a paint can mixer devices and methods are described for illustrative purposes and the underlying system can apply to any number and multiple types of paint. The paint can mixer devices and methods can be configured to include mixing in one-gallon paint cans and five-gallon paint cans using the present invention.

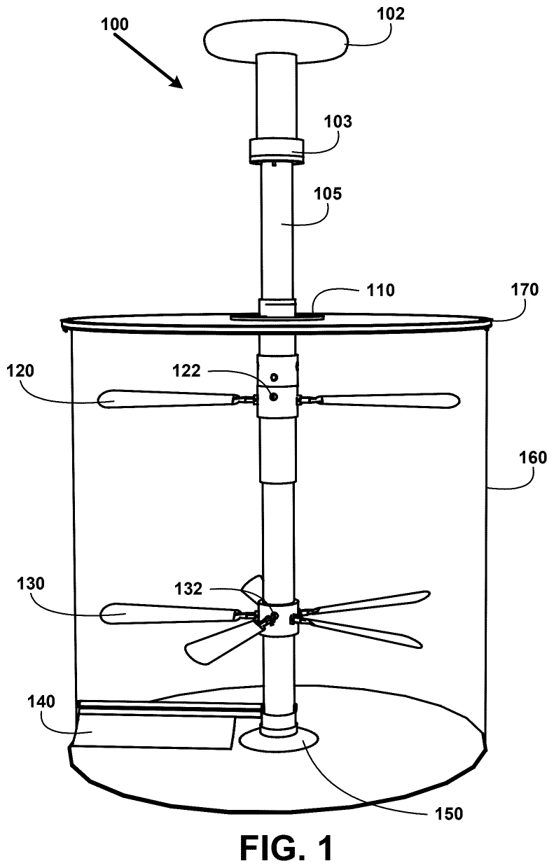

FIG. 1 shows for illustrative purposes only an example of a paint can mixer of one embodiment. FIG. 1 shows a paint can mixer 100 used to keep paint in a can 160 mixed properly to flow with a paint applicator including a brush, roller, or paint sprayer. The paint can mixer 100 performs the mixing process with the paint can lid 170 attached to prevent unintended splashing and paint being ejected from the can 160 without the lid 170 in place to stain objects and require solvent in some instances to clean up. A user can turn with one hand a ratcheted turn knob 102 in one direction. The rachet device 103 coupled to the ratcheted turn knob 102 applies force to spin the mixing blades that have been inserted into the paint can 160 and sealed with foldable blades and removable sealed cover 110. The paint can lid 170 is left in place to prevent spillage. In the opposite direction, the rachet device 103 allows the ratcheted turn knob 102 to turn freely in preparation for another twisting motion. The paint is mixed using two-blade foldable adjustable upper mixing blades 120 and five-blade foldable adjustable lower mixing blades 130. A squeegee 140 is attached to the mixer axle 105 near the bottom of the paint can 160. The mixer axle 105 is held in place with a bottom suction cup 150. The squeegee 140 stirs up any paint solids that have settled on the bottom and corners of the paint can 160. The paint can lid 170 can remain in place during the mixing process and as the mixing blades are lifted from the paint can 160 the paint on the blades will flow down into the paint can 160. Different types of paint, such as water-based, oil-based, or specialty paints, may require different mixing times. The paint can mixer 100 can mix any type of paint. The squeegee 140 speeds up the process by sweeping any solids from the corners and bottom of the paint can to add those to the mixing, which normally are not readily mixed without any physical contact of one embodiment.

### DETAILED DESCRIPTION

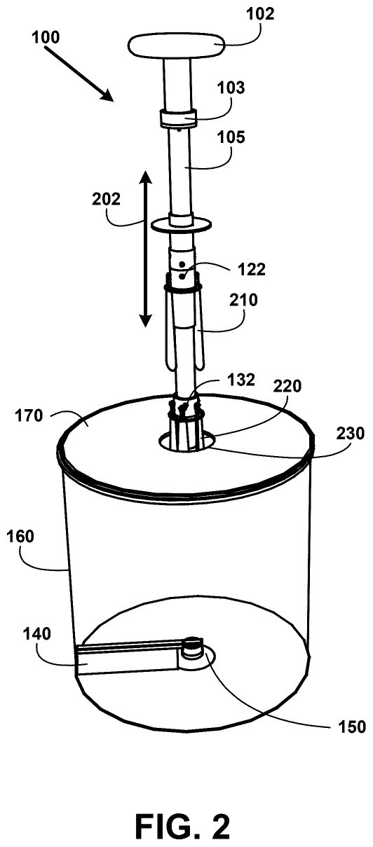

FIG. 2 shows for illustrative purposes only an example of foldable mixing blades of one embodiment. FIG. 2 shows the paint can mixer 100 of FIG. 1 coupling to the paint can 160. The ratcheted turn knob 102, rachet device 103, and mixer axle 105 are shown and used for inserting and removing the paint can mixer 202 from the paint can 160. Showing are the folded two-blade upper mixing blades 210 and folded five-blade lower mixing blades 220. The paint can lid 170 includes a sealable cover lid opening 230 used to install the paint can mixer 100 of FIG. 1. The sealable cover lid opening 230 allows the lid 170 to remain secured to the paint can 160. The squeegee 140 is foldable and attached to the bottom suction cup 150 shown detached from the mixer axle 105 for illustrative purposes. However, the foldable squeegee 140 and bottom suction cup 150 are attached to the mixer axle 105 before insertion into the paint can 160. When the paint can mixer 100 of FIG. 1 reaches the bottom of the paint can 160 pressure is applied to the top of the ratcheted turn knob 102 to create suction to maintain the axle position coupled to the bottom of the paint can of one embodiment.

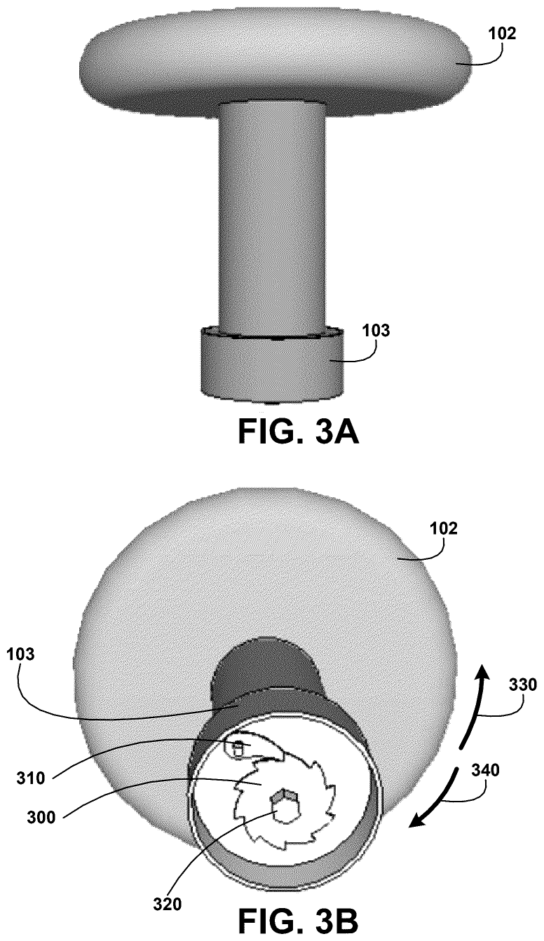

FIG. 3A shows for illustrative purposes only an example of a mixing handle of one embodiment. FIG. 3A shows the ratcheted turn knob 102 and the rachet device 103 in its housing section of the mixer axle 105 of FIG. 1 of one embodiment.

FIG. 3B shows for illustrative purposes only an example of a ratcheted stirring device of one embodiment. FIG. 3B shows the ratcheted turn knob 102 and rachet device 103. The rachet device 103 includes a rachet cog wheel 300, a rachet bar 310, and a hex shaft 320. The rachet bar 310 engages the rachet cog wheel 300 with knob twisting force to rotate the mixing blades. When twisted in the opposite direction the bar slips over the cogs and does not engage allowing the knob to freewheel. The hex shaft 320 inserts into the blade axle. The hex shape enables the force to be applied without slippage. The applied twist one-way turn to rotate blades 330 creates rotation and a twist opposite turn to reset rachet to turn blades again 340 and maintains the rotation in preparation for additional force to be applied with the next applied twist one-way turn of one embodiment.

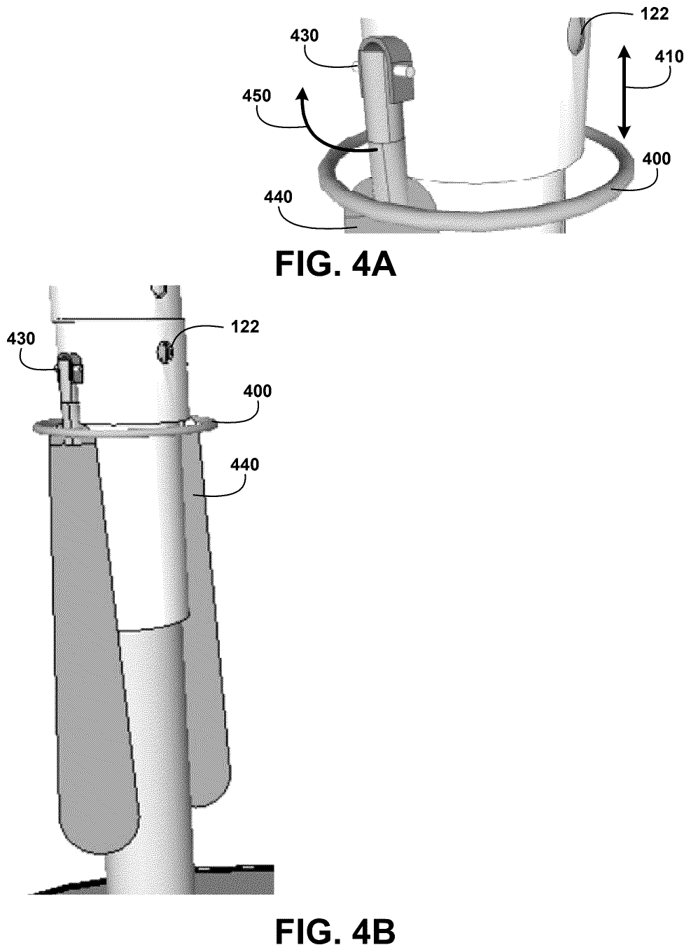

FIG. 4A shows for illustrative purposes only an example of blade hinges of one embodiment. FIG. 4A shows a retention ring 400 holding the blade in a folded position. The ring moves up as blades lift 410. The blade hinge 430 allows the blade 440 to unfold 450 and begin mixing the paint when the rotation begins of one embodiment.

FIG. 4B shows for illustrative purposes only an example of mixing blades folded of one embodiment. FIG. 4B shows the retention ring 400 and the blade hinge 430. The blade 440 is shown in a full-length folded position. The sealable cover lid opening 230 of FIG. 2 is of sufficient diameter to allow the blades to freely pass through the opening in a folded position of one embodiment.

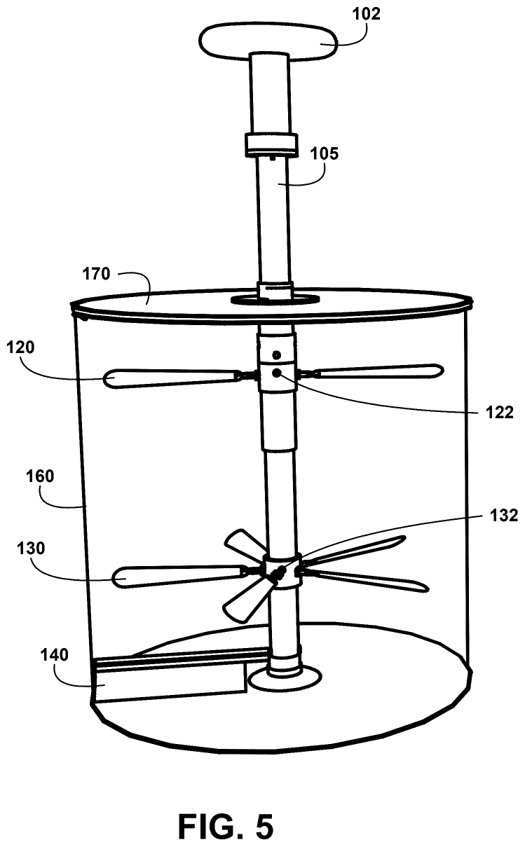

FIG. 5 shows for illustrative purposes only an example of the mixing blades deployed in the paint can of one embodiment. FIG. 5 shows deployed in the paint can coupled to the mixer axle 105, the ratcheted turn knob 102, upper mixing blades 120 and five-blade lower mixing blades 130, and the squeegee 140. The mixing blades are positioned below the paint can 160 lid 170 of one embodiment.

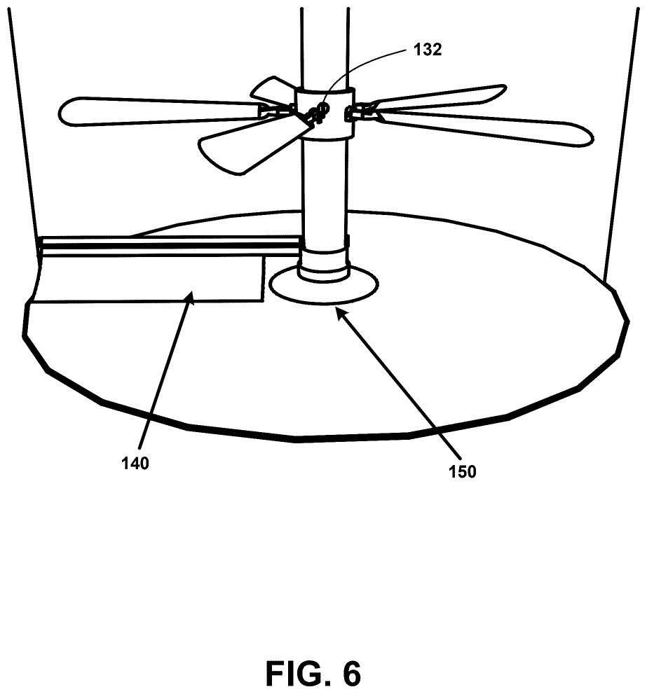

FIG. 6 shows for illustrative purposes only an example of the bottom and corner squeegee of one embodiment. FIG. 6 shows the squeegee 140 with a flexible blade that sweeps the bottom of the paint can 160 of FIG. 1. Shown is the corner joining of the side wall of the paint can 160 of FIG. 1. Solid pigments and other elements of the paint tend to settle in the corner and bottom surfaces. The squeegee 140 flexible blade fits into the corner and the length reaches across the bottom surfaces to loosen solid into the mixture of the combined paint elements. The bottom suction cup 150 is guided by the squeegee 140 to be in the center of the paint can bottom to allow the axle to be vertical in parallel with the sides of the paint can of one embodiment.

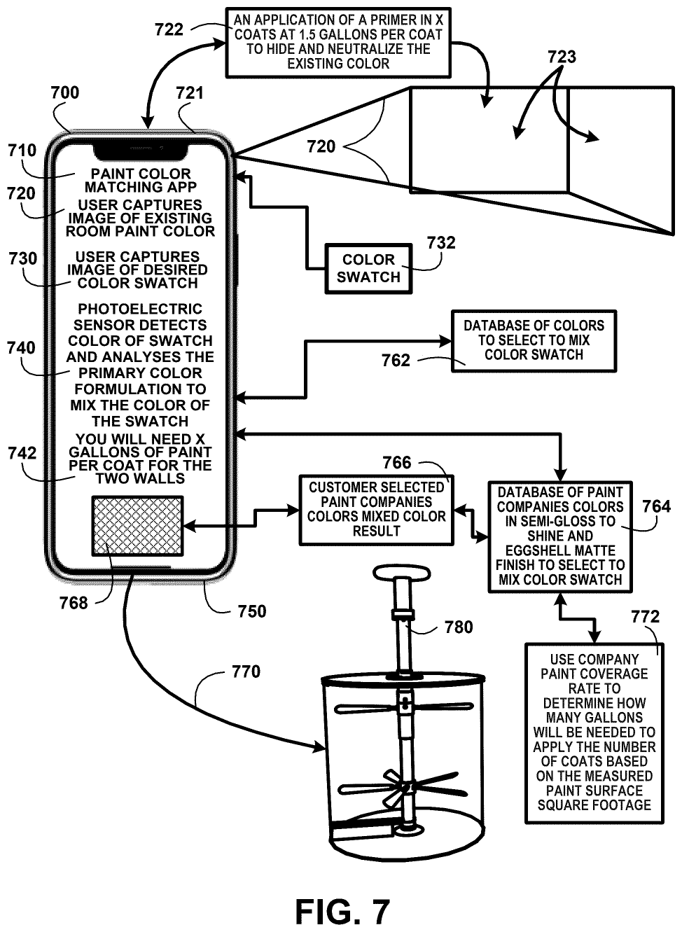

FIG. 7 shows for illustrative purposes only an example of a paint color-matching app of one embodiment. FIG. 7 shows a user's smartphone 700 having a paint color matching app 710 installed. The user captures an image of an existing room paint color 720 with the smartphone camera. The paint color matching app 710 includes a digital range finder 721 to determine the distance between the camera and the wall surface. The measured distance to the wall is used to scale the typical wall height of 8 feet and the floor length of the wall to calculate the square footage using a processor of the user's smartphone 700.

The paint color matching app 710 includes Augmented Reality (AR) showing the room walls. The user can change the color of the walls in the AR display 723 to match the color swatch 732. The user captures an image of the desired color swatch 730 to superimpose the swatch color to the walls.

At least one-color sensor of the paint color matching app 710. A photoelectric sensor detects color of swatch and analyses the primary color formulation to mix the color of the swatch 740 from base colors stored in a database. The at least one-color sensor can be at least one from a group of RGB Color Sensors, CMY Color Sensors, HSL/HSV Color Sensors, Color Photodiodes with Filters, Colorimetric Sensors, and photoelectric sensors.

The sensor will determine the proportions or percentages of paint colors, for example, the primary colors to match the desired color selected by the user. RGB sensors detect red, green, and blue light intensities, which are the primary colors used in most digital displays and imaging systems. These sensors typically consist of three photodiodes, each optimized for one of the primary colors, along with filters to isolate the specific wavelengths. By measuring the intensity of each primary color, RGB sensors can determine the color of an object and its composition in terms of red, green, and blue. CMY (Cyan, Magenta, Yellow) sensors work based on subtractive color mixing principles, commonly used in printing and color mixing applications. CMY sensors detect the reflected or transmitted light through color filters that simulate cyan, magenta, and yellow pigments. By measuring the absorption of each color, CMY sensors can determine the color of an object and its composition in terms of cyan, magenta, and yellow. HSL (Hue, Saturation, Lightness) or HSV (Hue, Saturation, Value) sensors measure color in terms of perceptual color attributes rather than primary colors. Hue represents the dominant wavelength, saturation indicates the purity of the color, and lightness/value represents the brightness. These sensors are often used in applications where human perception of color is more relevant than precise color composition.

The paint color matching app 710 uses the AR-captured images to determine the area coverage the user is planning, in this instance two walls. The paint color matching app 710 will display on the user's smartphone, a message, for example, “You will need x gallons of paint per coat for the two walls” 742

The paint color matching app 710 color sensor can determine the existing wall paint color and calculate an application of a primer in x coats at 1.5 gallons per coat to hide and neutralize the existing color 722. A primer coating will reduce the gallons of paint needed and prevent bleed-through of the existing color. The paint color matching app 710 will calculate the gallons of paint needed and display that amount, for example, “You will need x gallons of paint per coat for the two walls” 742. Estimating the volume of paint needed to cover a wall involves calculating the surface area of the wall and considering factors such as the type of paint, its coverage rate, the number of coats required, and the type of application, for example by brush, roller, or spraying.

The existing paint color may affect the number of coats. For example, an existing dark color being painted over with a lighter color may take 2 or 3 coats. The paint color matching app 710 color sensor can determine the existing wall paint color and estimate how many coats it may take to hide the existing color with the newly selected color and how many gallons of primer to hide the existing color.

The process can be repeated with a primer applied. An analysis of the color swatch 732 shows the color pigment mix to achieve the desired color. Multiple brand paint color selection data is stored on the user's smartphone memory device for a database of colors to select to mix color swatch 762. The paint color matching app 710 compares paint brand catalogs with colors 750 to build a database of paint companies'colors in semi-gloss to shine and eggshell matte finish to select to mix the color swatch match 764. The database is also used to determine if a match to the color swatch 732 is already commercially available. If no brand matches the swatch color, the paint color matching app displays the primary color mixing proportions to achieve the swatch color 770.

The database also allows the paint color matching app 710 to use company paint coverage rate to determine how many gallons will be needed to apply the number of coats based on the measured paint surface square footage 772. A customer-selected paint company's colors mixed color result 766 is displayed on the user's smartphone with an example of the paint company's colors mixed color result 768.

The paint color matching app 710 can also mix paint company colors selected from the stored colors to determine a match of paint company colors that reproduce the swatch color. A paint supplier mixes the color based on the primary color mixing proportions and fills one or more paint cans with the mixed color paint 772. The paint can mixer 100 of FIG. 1 provides a device to thoroughly mix the paint when ready for painting, to provide consistency in the color selected by the user 780 of one embodiment.

The foregoing has described the principles, embodiments, and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

1. A paint can mixer system, comprising:
a ratcheted turn knob coupled to a mixer axle, configured to rotate the mixer axle;
a ratchet device with a ratchet bar linked to the ratcheted turn knob, configured to engage the ratchet device when the turn knob is twisted in one predetermined direction;
multiple mixing blades attached to the mixer axle, the multiple mixing blades being configured to collapse for insertion through an opening in a lid attached to the paint can and configured to expand within an inside of the paint can for mixing when the mixer axle rotates, the lid including a sealable cover coupled to the paint can to contain the paint during mixing;
a suction cup having a sleeve coupled to the mixer axle and configured to allow independent rotation of the mixer axle relative to the suction cup, the suction cup further configured to removably attach by suction to an interior bottom surface of the paint can to secure and stabilize the mixer axle during rotation of the mixer axle and the multiple mixing blades;
a squeegee comprising a flexible elastomeric blade attached to the mixer axle, the flexible elastomeric blade having a resilient tip configured to conform to an interior sidewall and the bottom junction of the paint can to displace paint material from the interior sidewall and the bottom junction toward a central mixing region engaged by the multiple mixing blades;
a paint color matching application operating on a mobile device and configured to use a camera of the mobile device to calculate square footage of a surface and an augmented reality processor coupled to the camera and the paint color matching application configured to display on the mobile device a color in real time that matches a selected color swatch;
at least one-color sensor coupled to the paint color matching app, configured to analyze the mixture of primary paint colors to recreate a user-preferred new color based on captured sensor data; and
a color sensor analyzer coupled to the paint color matching app and coupled to the camera configured to identify a matching paint color from a database of stored colors, including those from various paint companies, to recreate the user-preferred new color.

2. The paint can mixer system of claim 1, further comprising a two-blade foldable adjustable upper mixing blades component coupled to the mixer axle configured to mix paint flowing towards the top of the paint can.

3. The paint can mixer system of claim 1, further comprising a five-blade foldable adjustable lower mixing blades component coupled to the mixer axle configured to mix paint flowing from the bottom of the paint can.

4. The paint can mixer system of claim 1, further comprising a lid with a lid opening and a lid opening sealable cover coupled to the lid, wherein the lid is configured to couple to the paint can to prevent spillage from the paint can while mixing paint within the paint can.

5. The paint can mixer system of claim 1, wherein a plurality of hinged foldable mixing blades coupled to the mixer axle configured to be inserted and removed from a the paint can through a sealable cover lid opening.

6. The paint can mixer system of claim 1, further comprising a range finder coupled to the user's digital device camera, configured to measure wall lengths and heights.

7. The paint can mixer system of claim 1, wherein the squeegee is configured with hinges to fold up when in contact with the paint can bottom surface and fold down when not in contact with the paint can bottom surface.

8. A paint can mixer system, comprising:
a ratcheted turn knob coupled to a mixer axle, configured to rotate the mixer axle;
a ratchet device with a ratchet bar linked to the ratcheted turn knob, configured to engage the ratchet device when the turn knob is twisted in one predetermined direction;
multiple mixing blades attached to the mixer axle, the multiple mixing blades being configured to collapse for insertion through an opening in a lid attached to the paint can and configured to expand within an inside of the paint can for mixing when the mixer axle rotates, the lid including a sealable cover coupled to the paint can to contain the paint during mixing;
a suction cup having a sleeve coupled to the mixer axle and configured to allow independent rotation of the mixer axle relative to the suction cup, the suction cup further configured to removably attach by suction to an interior bottom surface of the paint can to secure and stabilize the mixer axle during rotation of the mixer axle and the multiple mixing blades;
a squeegee comprising a flexible elastomeric blade attached to the mixer axle, the flexible elastomeric blade having a resilient tip configured to conform to an interior sidewall and the bottom junction of the paint can to displace paint material from the interior sidewall and the bottom junction toward a central mixing region engaged by the multiple mixing blades;
a paint color matching application operating on a mobile device and configured to use a camera of the mobile device to calculate square footage of a surface and an augmented reality processor coupled to the camera and the paint color matching application configured to display on the mobile device a color in real time that matches a selected color swatch;
at least one-color sensor coupled to the paint color matching app, configured to analyze the mixture of primary paint colors to recreate a user-preferred new color based on captured sensor data; and
a color sensor analyzer coupled to the paint color matching app and coupled to the camera configured to identify a matching paint color from a database of stored colors, including those from various paint companies, to recreate the user-preferred new color.

9. The paint can mixer system of claim 8, further comprising two-blade foldable adjustable upper mixing blades coupled to the mixer axle configured to mix paint flowing towards the top of the paint can.

10. The paint can mixer system of claim 8, further comprising five-blade foldable adjustable lower mixing blades coupled to the mixer axle configured to mix paint flowing from the bottom of the paint can.

11. The paint can mixer system of claim 8, further comprising a lid with a lid opening and a lid opening sealable cover coupled to the lid, wherein the lid is configured to couple to the paint can to prevent spillage from the paint can while mixing paint within the paint can.

12. The paint can mixer system of claim 8, wherein a plurality of hinged foldable mixing blades coupled to the mixer axle configured to be inserted and removed from the paint can through a sealable cover lid opening.

13. The paint can mixer system of claim 8, wherein a plurality of hinged foldable mixing blades coupled to the mixer axle configured to allow the foldable mixing blades to fold up when spinning and fold down when not spinning.

14. The paint can mixer system of claim 8, wherein the squeegee is configured with hinges to fold up when in contact with a paint can bottom surface and fold down when not in contact with the paint can bottom surface.

15. A paint can mixer system, comprising:
a ratcheted turn knob coupled to a mixer axle, configured to rotate the mixer axle;
a ratchet device with a ratchet bar linked to the ratcheted turn knob, configured to engage the ratchet device when the turn knob is twisted in one predetermined direction;
multiple mixing blades attached to the mixer axle, the multiple mixing blades being configured to collapse for insertion through an opening in a lid attached to the paint can and configured to expand within an inside of the paint can for mixing when the mixer axle rotates, the lid including a sealable cover coupled to the paint can to contain the paint during mixing;
a suction cup having a sleeve coupled to the mixer axle and configured to allow independent rotation of the mixer axle relative to the suction cup, the suction cup further configured to removably attach by suction to an interior bottom surface of the paint can to secure and stabilize the mixer axle during rotation of the mixer axle and the multiple mixing blades;
a squeegee comprising a flexible elastomeric blade attached to the mixer axle, the flexible elastomeric blade having a resilient tip configured to conform to an interior sidewall and the bottom junction of the paint can to displace paint material from the interior sidewall and the bottom junction toward a central mixing region engaged by the multiple mixing blades;
a paint color matching application operating on a mobile device and configured to use a camera of the mobile device to calculate square footage of a surface and an augmented reality processor coupled to the camera and the paint color matching application configured to display on the mobile device a color in real time that matches a selected color swatch;
at least one-color sensor coupled to the paint color matching app, configured to analyze the mixture of primary paint colors to recreate a user-preferred new color based on captured sensor data; and
a color sensor analyzer coupled to the paint color matching app and coupled to the camera configured to identify a matching paint color from a database of stored colors, including those from various paint companies, to recreate the user-preferred new color.

16. The paint can mixer system of claim 15, further comprising a lid with a lid opening and a lid opening sealable cover coupled to the lid, wherein the lid is configured to couple to the paint can to prevent spillage from the paint can while mixing paint within the paint can.

17. The paint can mixer system of claim 15, wherein the squeegee is configured with hinges to fold up when in contact with a paint can bottom surface and fold down when not in contact with the paint can bottom surface.

18. The paint can mixer system of claim 15, wherein a plurality of hinged foldable mixing blades coupled to the mixer axle configured to be inserted and removed from a paint can through a sealable cover lid opening.

19. The paint can mixer system of claim 15, further comprising a lid with a lid opening and a lid opening sealable cover coupled to the lid, wherein the lid is configured to couple to the paint can to prevent spillage from the paint can while mixing paint within the paint can.

20. The paint can mixer system of claim 15, further comprising a range finder coupled to the user's digital device camera, configured to measure wall lengths and heights.
